(19) United States
(12) Patent Application Publication
(10) Pub. No.: US 2021/0298388 A1
(43) Pub. Date: Sep. 30, 2021

(54) LOUPE LIGHT-COMPATIBLE ATTACHABLE FACE SHIELD

(71) Applicant: Sarah NABAI, Palo Alto, CA (US)

(72) Inventor: Sarah NABAI, Palo Alto, CA (US)

(21) Appl. No.: 17/211,652

(22) Filed: Mar. 24, 2021

Related U.S. Application Data
(60) Provisional application No. 62/994,249, filed on Mar. 24, 2020.

(51) Int. Cl. A41D 13/11

(52) U.S. Cl. CPC A41D 13/1184; A41D 13/1115

(57) ABSTRACT

A face shield adapted to protect the face from biohazards during medical procedures is disclosed. The central portion of the face shield includes a horizontally centered cut out that extends downwardly from a top edge or top portion. The cut out is sized and positioned to allow a loupe light to pass through. The face shield includes two or more post openings for use in coupling the shield to a shield frame. The shield frame is worn about the user's head without relying on attachment to a pair of loupes (if worn). The shield has left and right side portions that extend along and attach to posts along the sides of the frame.

### CROSS REFERENCE TO RELATED APPLICATIONS

This application claims the benefit of U.S. Provisional Patent Application 62/994,249, filed Mar. 24, 2020. This application is related to U.S. patent application Ser. No. 15/234,931 entitled “LOUPE LIGHT-COMPATIBLE ATTACHABLE FACE SHIELD” filed on Aug. 11, 2016, which is herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD

The invention relates to disposable body substance isolation equipment, and in particular, to medical masks with eye shields that are compatible with loupe lights

### BACKGROUND

Over the last several decades, both medical professionals and the general public have become far more aware of the dangers of pathogens in bodily fluids. Some of the pathogens themselves have become increasingly virulent, and drug resistance has become an issue with strains of bacteria that were once easily eradicated using standard antibiotics.

Products that are intended to prevent a medical practitioner from coming into contact with potentially infectious bodily fluids are referred to generally as body substance isolation (BSI) equipment. One of the most common types of BSI equipment is the face mask.

Face masks exist in several forms, perhaps the most common of which is the filter mask. A filter mask is essentially a piece of material that is worn over the nose and mouth to filter the incoming and outgoing breath, thus preventing the wearer from being infected by others and others from being infected by the wearer. The filter mask is typically tied around the back of the head and neck, or includes elastic straps that are looped over the ears. Surgeons typically wear this kind of face mask during most surgical procedures, and some patients with chronic conditions, like tuberculosis, may routinely wear filter masks to prevent others from becoming infected.

Filter masks may be adequate for some applications where small droplets in the breath are the primary concern. However, for applications in which blood and other bodily fluids may splash or splatter, full-face protection may be more desirable. For example, full-face protection is becoming increasingly common in dental offices, where the dentist or hygienist has close contact with the patient.

Full-face protection is also becoming increasingly prevalent as a means for protection during a pandemic. As recently seen, pathogens, such as the SARS-CoV-2, have become increasingly virulent, which can and has resulted in a global pandemic. Full-face protection is a recommended preventative measure in light of such a pathogen, and can be even more important in the setting of a dental office.

There are several common options for full-face protection. The first, and perhaps most complete, is a helmet-style shield that fits over the head and covers the face entirely. In some versions, the face shield portion may rotate up and out of the way when not needed. Although effective and able to offer full wrap-around protection of the head and face, this equipment is cumbersome, and can be hot and uncomfortable to wear.

A second, lighter option is a filter mask with an integrated plastic face shield. In masks of this sort, a clear piece of plastic is attached to and around the filter mask and extends upwardly to cover the face. While useful, and often more comfortable than a helmet-style shield, these disposable integrated face shields often do not have good wrap-around coverage of the face, i.e., they may offer poor protection for the side of the face and are not contoured to fit the face well.

Another problem with the standard disposable integrated face shield is that medical providers often wear glasses or other equipment on their faces. For example, it is extremely common for a medical provider to wear a set of loupes. Loupes bear a general resemblance to glasses, and typically include magnifiers (2.5× and 3.5× are common magnifications) as well as a light. When worn, a loupe light is typically centered on the brow, just above the bridge of the nose. Unfortunately, standard disposable face shields cannot accommodate this kind of equipment, which projects out from the face. Use of such face shields with loupes can also cause glare distortion and excessive heat if the loupe light is positioned behind the shield.

### SUMMARY OF THE DISCLOSURE

In some embodiments a protective shield and frame is provided. The protective shield and frame comprise a shield frame having a central portion, a left side portion, a left end, a right side portion and a right end; at least two shield posts extending from the shield frame; and a protective shield having at least two post openings formed in the shield positioned so that the shield may be releasably attached to the shield frame, the post openings comprising fully formed or partially formed openings or perforations defining the openings, wherein the at least two shield posts are configured to be inserted into the at least two post openings.

In some embodiments, the protective shield comprises an opening sized to accommodate a loupe light. The opening can be frangible. The opening can be a circle or an oval. The opening can be a U-shaped slot. The opening can comprise a flap in which at least a portion of the opening is continuously connected to the shield. A top edge of the opening can be positioned below a top portion of the protective shield.

The post opening can comprise one or more slits. The protective shield and frame can comprise about 3-7 shield posts. The protective shield and frame can comprise about 307 post openings.

In some embodiments, the shield frame comprises a standoff configured to space the protective shield away from a user's face. The standoff can be configured to space the protective shield about 1-2″ from the user's face. The standoff can comprise plastic or foam. The standoff can comprise a length of foam extending along the shield frame. The standoff can comprise one or more plastic components that extend from the shield frame to a forehead rest portion of the standoff. The forehead rest portion of the can comprise an edge of the standoff. In some embodiments, the forehead rest portion comprises a foam or other conformable material. A front edge of the standoff and shield frame can be discontinuous along at least a portion of the front edge of the standoff.

When worn by a user, the left end and the right end may extend the user's ears, be adjacent to the user's ears or be along the user's temples. The let end and the right end may be spaced apart by 0.5 inches, 1 inch, 1.5 inches, 2.5 inches or 3 inches. An angle formed by the left side portion, the central portion and the left end may be between 0 degrees and 90 degrees.

In some embodiments, an angle formed by the right side portion, the central portion, and the right end is between 0 degrees and 90 degrees.

The post shape may be circular, square, rectangular, oval, polygon or a hybrid and the one or more post openings are adapted for securing the shield to the shield frame using the post shape. In some embodiments, the post cross section shape has a flared tip, a ball tip, a platform tip, a hollow portion for use with a T-post, a post for use with a cap or a post with a recess and the one or more post openings are adapted for securing the shield to the shield frame using the post shape. The post can comprise a base and a head portion comprising a greater width or diameter than the base. The shield posts can be positioned along a front portion of the shield frame. The shield posts can be spaced along a front portion of the shield frame from a position at or near the right end to a position at or near the left end.

In some embodiments, the protective shield comprises a greater width at a top portion of the shield than a bottom portion of the shield.

The shield frame can comprise a hook or aperture at or near its right end or left end.

In some embodiments, the protective shield and frame comprise a strap connecting the right end of the frame to the left end of the frame.

In another aspect, a method of providing protection to a user is provided. The method comprises donning the protective shield and frame as described herein.

The method can comprise donning a pair of loupes; adapting the face shield to accommodate the loupes light if needed; and wearing the shield frame and shield with the loupes light protruding through the shield and the shield frame worn spaced above the temples of the loupes.

In some embodiments, a protective shield is provided. The protective shield comprises a protective shield comprising a thin sheet of clear material, the protective shield comprising a strap connector and a first end and a second end of a top portion of the protective shield; and a spacer attached to the top portion of the protective shield and comprising a thickness of about 0.5″-2.5″.

The strap connector can comprise a fully or partially formed opening. The protective shield can comprise a strap comprising a strap first end inserted through the strap connector on the first end of the protective shield and a strap second end inserted through the strap connector on the second end of the protective shield. The strap first end and/or the strap second end can comprise one or more notches. The strap connector can comprise one or more slits.

A strap can extend from the strap connector on the first end to the strap connector on the second end.

The spacer can comprise foam.

The protective shield can further comprise an opening to accommodate a loupe light. The opening can be frangible. The opening can be a circle or an oval. The opening can be a U-shaped slot. The opening can comprise a flap in which at least a portion of the opening is continuously connected to the shield. A top edge of the opening can be positioned below a top portion of the protective shield.

In another aspect, a method of providing protection to a user is provided. The method comprises donning the protective shield and frame as described herein.

The method can comprise donning a pair of loupes; adapting the face shield to accommodate the loupes light if needed; and wearing the shield frame and shield with the loupes light protruding through the shield and the shield frame worn spaced above the temples of the loupes.

A further aspect of the invention relates to a face shield. The face shield comprises a thin, transparent sheet of material with a central portion connected to two side portions. The central portion includes an opening essentially horizontally centered on the central portion and positioned vertically some distance down from a top edge of the central portion. The opening is sized to admit a loupe light. While some embodiments include side portions with attachment structure, such as a clip, that is adapted to attach the face shield to one of the temples of a pair of loupes, there is a need for additional shield frames which require no attachment to but maintain compatibility with the use of loupes.

These and other aspects, features, and advantages of the invention will be described below.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

The invention will be described with respect to the following drawing figures, in which like numerals represent like features throughout the drawings, and in which:

FIG. 1 is a perspective view of a medical mask with a loupe light-compatible eye shield according to one embodiment of the invention;

FIG. 2 is a perspective view of a medical mask according to another embodiment of the invention;

FIG. 3 is a front elevational view of the mask of FIG. 1;

FIG. 4 is a perspective view of an attachable face shield according to another embodiment of the invention;

FIG. 5 is a top plan view of the attachable face shield of FIG. 4 shown in isolation;

FIG. 6 is a perspective view of an attachable face shield according to yet another embodiment of the invention; and

FIG. 7 is a perspective view of an attachable face shield according to a further embodiment of the invention.

FIG. 8 is a top down view of a shield frame embodiment.

FIG. 9 is a front view of a full face protective shield having a central opening sized for a loupe light and openings sized and shaped for securing the protective shield to a shield frame post.

FIG. 10A is a front view of a full face protective shield of FIG. 9 coupled to the shield frame of FIG. 8 worn by a user who is wearing a pair of loupes with the loupe light shown in the opening of the protective shield.

FIG. 10B is a front view of an alternative embodiment of a full face protective shield of FIG. 9 having a loupe light opening formed so that a central post opening is provided for an additional attachment point to the shield frame.

FIG. 10C is a front view of an alternative embodiment of a full face protective shield of FIG. 10B having a frangible loupe light opening, two oval shaped post openings on either side and one centrally located post opening and an upper edge extending above the post openings for additional coverage of the user's head.

FIG. 11 is a flow chart of an exemplary method of selecting a protective face shield for use with a shield frame and donning the shield frame while wearing a pair of loupes.

FIG. 12A is a front view of a partial face protective shield coupled to a shield frame.

FIG. 12B is a partial right side view of the partial face protective shield coupled to a shield frame of FIG. 12A.

FIG. 13A is a front view of a partial face protective shield coupled to a shield frame of FIG. 12A worn by a user wearing loupes.

FIG. 13B is a partial right side view of the partial face protective shield coupled to a shield frame of FIG. 12A worn by a user wearing loupes.

FIG. 14A is a face protective shield adapted for use with a shield frame having an elongated opening for a loupe light and a mixture of post openings corresponding to those on the shield frame.

FIG. 14B is a face protective shield adapted for use with a shield frame having an elongated frangible opening for a loupe light and a mixture of post openings corresponding to those on the shield frame.

FIG. 15A is a face protective shield adapted for use with a shield frame having a circular opening for a loupe light and a pair of rectangular post openings corresponding to those on the shield frame.

FIG. 15B is a face protective shield adapted for use with a shield frame having an circular frangible opening for a loupe light and a pair of oval shaped post openings corresponding to those on the shield frame.

FIG. 16 is a face protective shield adapted for use with a shield frame having a frangible flap opening for a loupe light and a combination of paired side post openings, a central post opening, and another pair of side post openings corresponding to those on the shield frame.

FIG. 17A illustrates a partial cross section of a portion of a shield frame and a post having a flared tip.

FIG. 17B illustrates a partial cross section of a portion of a shield frame and a post having a ball or rounded tip.

FIG. 17C illustrates a partial cross section of a portion of a shield frame and a post having a platform or plateau shaped tip.

FIG. 17D illustrates a partial cross section of a portion of a shield frame and a hollow post adapted for use with a T-insert to secure the shield to the shield frame.

FIG. 17E illustrates a partial cross section of a portion of a shield frame and a post adapted for use with a cap to secure the shield to the shield frame.

FIG. 17F illustrates a partial cross section of a portion of a shield frame and a post having a platform or plateau shaped tip similar to FIG. 17C with a recess formed in the post. A recess may be provided to secure the shield at a spacing from the shield frame or to allow space for a gasket, seal or other material on the shield frame to be disposed between the shield frame and the shield.

FIG. 18A is a top down view of a post showing an overall circular shape.

FIG. 18B is a top down view of a post showing an overall square shape.

FIG. 18C is a top down view of a post showing an overall rectangular shape.

FIG. 18D is a top down view of a post showing an overall oval shape.

FIG. 18E is a top down view of a post showing an overall polygonal shape.

FIG. 18F is a top down view of a post showing an overall hybrid shape.

FIG. 19A is a bottom up view of a shield frame having one or more slots, grooves or receivers to engage with a correspondingly shaped tab on a protective shield adapted for use with the shield frame.

FIG. 19B is a front view of a protective shield having a series of tabs along the upper edge that are adapted to engage with a corresponding slot, groove or receiver formed in a surface of the shield frame.

FIG. 20A is a perspective view of an embodiment of a protective shield and a shield frame.

FIG. 20B is a front view of the protective shield of FIG. 20A.

FIG. 20C shows a front view of an embodiment of a post opening.

FIG. 20D shows a perspective view of an embodiment of the shield frame of FIG. 20A.

FIG. 20E shows a top view of an embodiment of a support post.

FIG. 20F is a front view of the protective shield and shield frame of FIG. 20A.

FIG. 20G is a top view of the protective shield and shield frame of FIG. 20A.

FIG. 20H is a perspective view of a user wearing the protective field and shield frame of FIG. 20A.

FIG. 21A is a front perspective view of an embodiment of a protective shield.

FIG. 21B is a top view of the protective shield of FIG. 21A.

FIG. 21C is a back perspective view of the protective shield of FIG. 21A.

FIG. 21D is a perspective view of a user wearing the protective shield of FIG. 21A.

### DETAILED DESCRIPTION

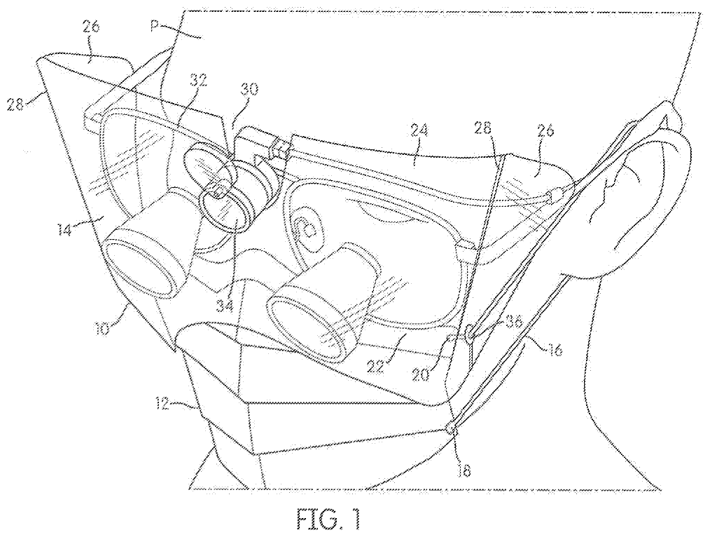

FIG. 1 is a perspective view of a medical mask with a loupe light-compatible eye shield, generally indicated at 10, according to one embodiment of the invention, shown as worn on the head of a person P. The medical mask 10 includes both a filter mask portion 12 and a face shield portion 14.

The filter mask portion 12 is a pleated sheet of natural or polymer fibers that is extended over the nose and the mouth, down to and beyond the level of the chin. The construction of filter masks is well known in the art, and any known materials may be used for the filter mask portion 12. The material of which the filter mask portion 12 is made may depend on any number of factors, including the size of particulate or aerosol matter that the filter mask portion 12 is intended to filter. In the illustrated embodiment, the medical mask 10 and filter mask portion 12 are secured by a pair of elastic straps 16, each of which is secured to the filter mask portion 12 at two locations 18, 20. Depending on the embodiment, the straps 16 may be sewn or fused to the filter mask portion 12, or simply passed through it and knotted. Of course, inextensible tied straps or other methods of securement may be used instead of elastic straps 16.

Provided above the filter mask portion 12 and covering the eyes, brow, and sides of the face in FIG. 1 is the face shield portion 14. The face shield portion 14 is attached at its left and right edges to the left and right edges of the filter mask portion 12, typically by fusing, adhesives, or any other known means. The bottom edge of the face shield portion 14 is typically free to move relative to the filter mask portion 12, and an upper strip 22 of the filter mask portion 12 includes an embedded malleable metal strip that can be contoured to fit the nose. As shown, there is some overlap between the filter mask portion 12 and the face shield portion 14; the face shield portion 14 extends below the top of the filter mask portion 12 and terminates in a concave curve with a high point proximate to the tip of the nose, which helps to accommodate the nose. Of course, the bottom curvature of the filter mask portion 12 may vary from embodiment to embodiment, and in some embodiments, the filter mask portion 12 may be squared off.

The face shield portion 14 itself is made from a thin, transparent sheet of material, and includes a central portion 24 and two side portions 26. The side portions 26 are connected to the central portion 24 by respective hinges 28, which may, for example, be living hinges or scores that allow the two side portions 26 to fold and bend relative to the central portion 24. This, in turn, may allow better coverage of the sides of the face as compared with conventional face masks, in which there are no hinges and the plastic simply wraps around the face as best it can. The hinges 28 may also reduce the tendency for the face shield portion 14 to warp, crimp, or distort, which may interfere with the provider's view or be uncomfortable.

Additionally, the central portion 24 of the face shield portion 14 defines a cut out 30. The cut out 30 is essentially horizontally centered on the face shield portion 14, and extends downwardly from a top edge of the face shield portion 14. As shown in FIG. 1, when a user is wearing loupes 32 with a loupe light 34, the cut out 30 allows the loupe light 34 to pass through the face shield portion 14, thus making it easier to wear loupes 32, a loupe light 34, and the mask 10 at the same time.

A cut out in the face shield portion can also advantageously allow access to a UV filter attachment on the loupe light. For example, when placing UV sensitive filling material or cements, a user needs access to the loupe light to place the UV filter on the light to slow down the curing process. The user also needs to access the light to remove to the UV filter attachment to finish the procedure. Allowing the user access to the loupe light without having to remove the face shield can greatly increase convenience, hygiene, and/or safety of the procedure.

The cut out 30 of the illustrated embodiment is wider at the top and narrower at the bottom, and the bottom may be rounded (i.e., to match or approximate the curvature of a typical loupe light 34). The shape of the cut out 30 may be different in other embodiments—for example, the bottom may be squared, and the top may have a different taper or no taper at all. In one embodiment, for example, the cut out 30 may be about 2.5 inches at its top, about 2 inches at its bottom, and with a height of about 2.5 inches, which provides enough room to accommodate a typical loupe light 34. However, other embodiments may use different dimensions, and as was noted above, the cut out 30 need not taper in all embodiments. In other words, the cut out 30 may have straight sides and a rounded bottom or straight sides and a squared-off bottom.

While the sidewalls of the cut out 30 are completely straight in the illustrated embodiment, that need not be the case in all embodiments. The sidewalls may instead have curvature of various types, either continuous or discontinuous. In other words, the sidewalls may be only substantially—but not completely—straight, or they may not be straight at all. However, a straight-sided cut out 30 may be easier to manufacture.

As a general matter, it is advantageous if the cut out 30 has the minimum dimensions necessary to admit the loupe light 34. Put another way, it is advantageous if the cut out 30 admits the loupe light 34 but otherwise compromises the protective function of the face shield portion 14 as little as possible. As can be appreciated from the figures, the cut out 30 is more vertical than horizontal. Put another way, the width is typically at most equal to the depth, and in many cases, the cut out 30 may be deeper than it is wide.

In some embodiments, masks 10 may be made with no cut out 30. In other embodiments, masks may be made with a perforated frangible portion that can be torn off to create a cut out like the cut out 30 illustrated in FIG. 1. Of course, the user is under no obligation to remove a frangible portion if one is present, and may use a face mask without removing a frangible portion if, for example, he or she does not wish to wear a loupe light 34.

In embodiments of the invention, the straps 16 or ties that secure the mask 10 to its wearer may cooperate with the side portions 26 to secure them around the sides of the face or otherwise maintain their position, creating a wrap-around effect.

As shown in FIG. 1, the top half of each elastic strap 16 passes through a hole 36 defined toward the bottom of the side portion 26, emerges on the outside of the side portion 26 and, because of the tension in it, presses against the side portion 26 and keeps it against the face as the strap 16 extends toward and around the ear.

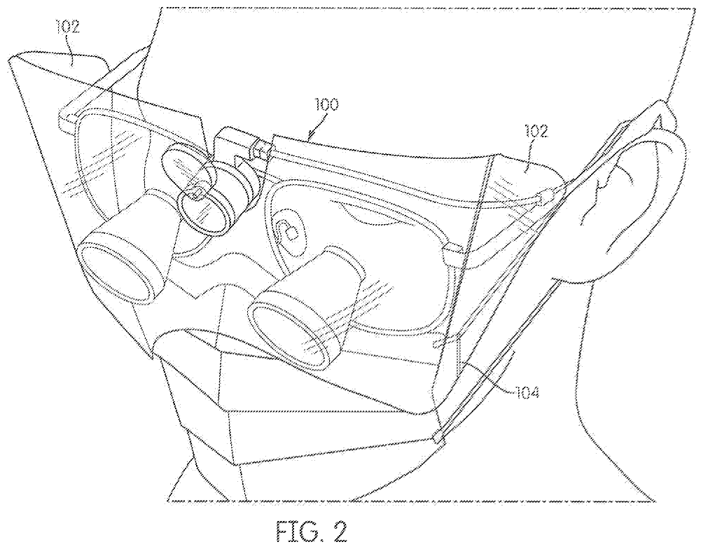

Each hole 36 may be reinforced, for example, by an additional layer or layers of plastic fused or sintered around each hole 36. However, the holes 36 need not be reinforced. In fact, the side portion 26 need not have a hole 36 per se; instead, any kind of opening of sufficient size to allow the strap 16 to pass may be used. As one example, FIG. 2 is a perspective view similar to the view of FIG. 1 illustrating another embodiment of the invention, generally indicated at 100. The face mask 100 has essentially the same features as the mask 10 described above. However, in each side portion 102, a slit 104 extends from the bottom edge up. The slit 104 has an upwardmost point at about the same position where a hole 36 would be in mask 10. In some embodiments, the slit 104 may terminate in a hole, although it need not. In some embodiments, there may be no opening in the side portion 26, 102 at all.

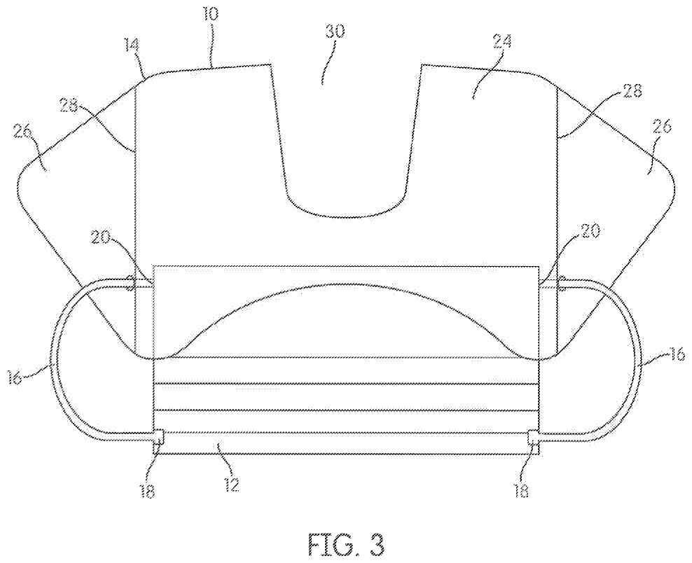

FIG. 3 is a front elevational view of the mask 10 of FIG. 1, illustrating how the mask 10 appears when not in use. One advantage of the mask 10 is that when not in use, it is essentially flat, making it easier to package and ship. However, it should be understood that although the filter mask portion 12 of the illustrated embodiment is a pleated flexible material that contours to the face, in other embodiments, the filter mask portion could be a dome-shaped mask with sufficient rigidity to hold its own shape. Masks of this type are known, and are often used to filter dust and other particulate matter.

While the mask 10 provides comprehensive protection, with integrated filter mask and face shield portions 12, 14, there are cases in which it may be advantageous for the two components to be separate. For example, this would allow the wearer to use a different style or type of mask, like a dome-shaped mask, and to tie off that mask in a different way than an integrated mask 10 would allow.

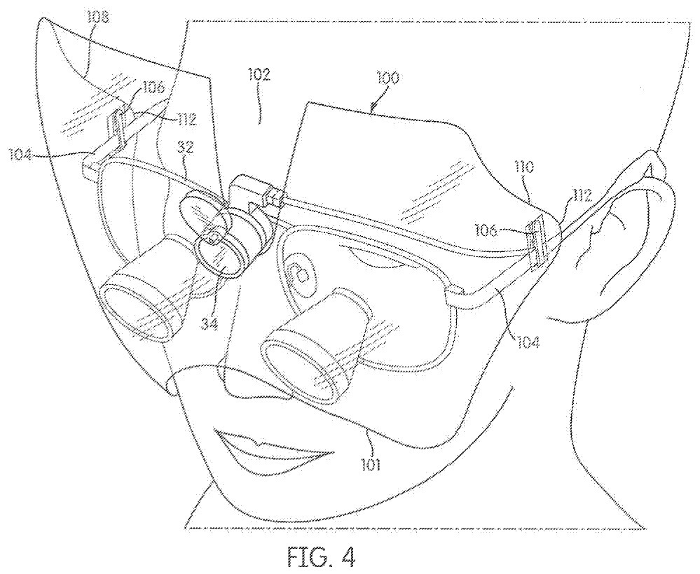

FIG. 4 is a perspective view of a face shield, generally indicated at 100, according to another embodiment of the invention. The face shield 100, like the face shield portion 14, comprises a thin, relatively flexible sheet of plastic. Typically, the face shield 100 has enough rigidity to hold the shape shown in FIG. 4, but is also flexible, as will be described below in more detail. For example, the face shield portion 14 may be 4 mil (0.1 mm) polyethylene terephthalate (PET). In embodiments of the invention, the face shield portion 14 and face shield 100 may be PET, polycarbonate, or another such transparent, durable material.

While much of this description may assume that the face shield 100, like the face shield portion 14, is transparent and clear, in some cases, shields 14, 100 may be made in other colors or with particular light-blocking properties. For example, dentists often use UV-curing adhesives in procedures, and a face shield 100 could be a UV filter, in which case, it would typically appear orange. In some cases, only the portion of the face shield 100 that lies over the eyes need have UV-filtering capabilities. In that case, a UV-filtering strip could be applied to the face shield with adhesives or by fusing the two layers together at manufacture.

As shown in FIG. 4, when in use, the face shield 100 extends from a line along the forehead down to the cheeks but, as in the previous embodiment, sweeps upward with a concavely curved lower edge 101, terminating at its highest point just above the point of the nose. Thus, the face shield 100 protects roughly the same area as the face shield portion 14, although it may extend farther up along the forehead, if desired or necessary. As those of skill in the art will appreciate, the face shield 100 may be made in different sizes, if necessary, to maintain the same coverage areas for people with differently sized or shaped faces.

The face shield 100 is constructed and adapted to protect a user wearing loupes 32 with a loupe light 34, and to allow the loupe light 34 to pass through. As with the face shield portion 14, the face shield 100 has a cut out 102. The cut out 102 has the same general features as the cut out 30 described above, although if the face shield 100 extends farther up along the forehead, the cut out 102 may be deeper than the cut out 30 of the face shield portion 14. The dimensions of the cut out 102 will be described in greater detail below.

Compared with the integrated mask 10 described above, the face shield 100 is held in place in an entirely different way: it attaches releasably to the temples 104 of the loupes 32. In the illustrated embodiment, two small clips 106 are fastened to the inner side of the face shield 100 near its left and right edges. The clips 106 are alligator clips—they are spring-loaded with serrated jaws. However, other forms of clips and attachment hardware may be used. Because of the clips 106, the face shield 100 does not need to be attached around the ears or around the circumference of the head, which may make for more comfortable wear by the user. As can be seen in the figures, no straps are provided.

Although one clip 106 is used on each side of the face shield 100 in the illustrated embodiment, more than one clip 106 may be used on each side if necessary or desirable for stability. Alternatively, the clip 106 or other method of securement may make contact over a wider area of each temple 104. For example, instead of clips 106, hook-and-loop fastener or adhesive tape may be used, and those methods would typically involve coverage over a wider area. Small elastic bands may also be used to attach the face shield 100 to the temples 104.

As can be seen in FIG. 4, the side portions 108, 110 that carry the clips 106 taper along the top and bottom edges and terminate at broad, rounded points 112 midway along the temples 104 of the loupes 32, giving them a concave triangular shape. The clips 106 are mounted just inward of those points 112. As can also be seen in FIG. 4, the side portions 108, 110 are contiguous with the rest of the face shield 100—there is no break or dividing line between them. In essence, the face shield 100 is flexible, and is simply bent around the loupes 32 and secured to the temples 104 with the clips.

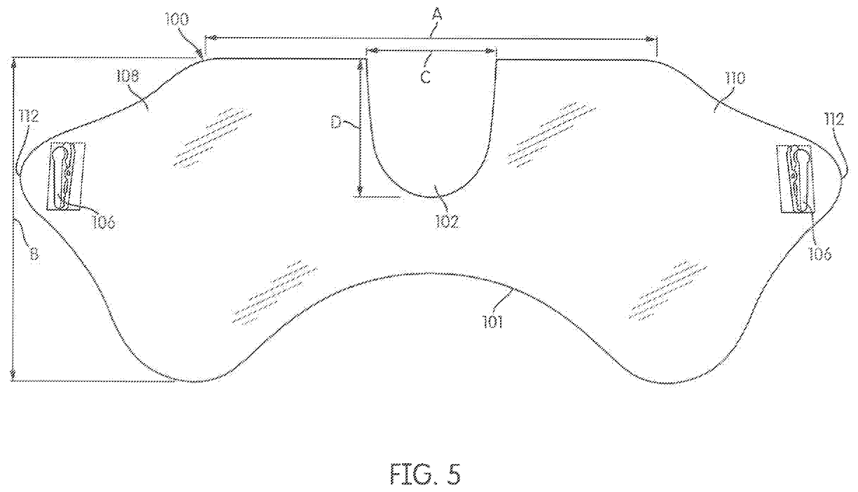

FIG. 5 is a top plan view of the face shield 100 in isolation, showing its dimensions. In particular, the face shield 100 has a main width, identified in FIG. 5 as A, excluding the side portions 108, 110, of about 7 inches, and a maximum height, identified in FIG. 5 as B, of about 5 inches. In this embodiment, the cut out 102 has a maximum height, C, of 2.5 inches and a maximum width at the top along the top edge, D, of 2.125 inches, and a maximum height or depth, D, of 2.5 inches. The side portions 108, 110 may be, for example, about 3 inches measured along a side from the point of maximum height to the point 112. Thus, the cut out 102 of the face shield 100 is, like its counterpart described above, deeper than it is wide.

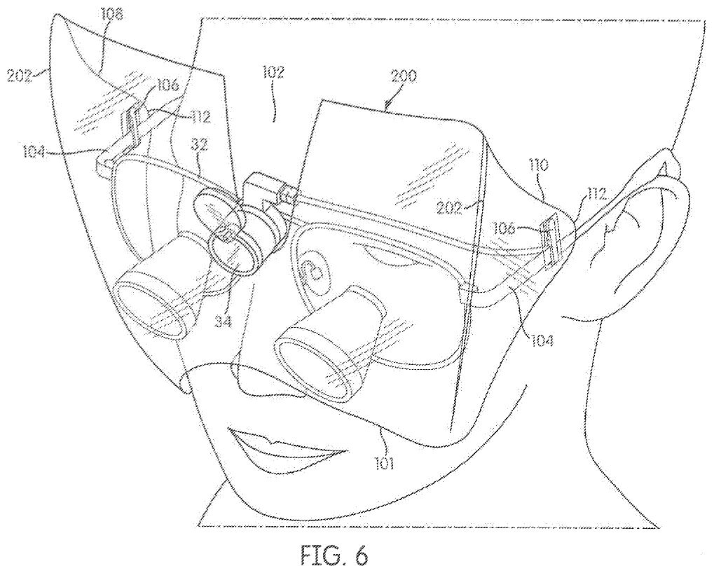

As was noted above, in the embodiment of FIGS. 4-5, the face shield 100 simply bends around the loupes 32 and is secured to the temples 104. That need not always be the case. FIG. 6 is a perspective view of another embodiment of a face shield, generally indicated at 200. The face shield 200 has features very similar to the features of the face shield 100, thus, except as noted, the description above applies to both face shields 100, 200. As compared to the face shield 100, the face shield 200 has score or fold lines 202 that divide the side portions 108, 110 from the rest of the face shield 200 and allow them to fold against the loupes 34. The face shield 200 with its fold lines 202 may be particularly useful in cases where it is necessary or desirable to make the face shield 200 thicker, for example, to hold its shape when large amounts of spatter or projectile contaminants are expected. There is no particular upper limit on the thickness of the face shields 100, 200, particularly if fold lines 202 are used, so long as the face shields 100, 200 are not so heavy that the loupes 32 shift position or slide down the nose.

Although FIGS. 4-6 illustrate the clips 106 attaching the face shields 100, 200 to the temples 104 of the loupes 32 at particular positions, any positions may be used. Typically, the user will select an attachment position that feels most comfortable and places the face shield 100, 200 as far forward as it needs to be to accommodate magnifiers and other features of the loupes 32.

Additionally, while FIGS. 4-6 illustrate the face shields 100, 200 with cut outs 102, in some embodiments, as with the face shield portion 14, the face shields 100, 200 may have frangible portions that can be torn out to form cut outs 102, rather than cut outs 102 themselves. This would be useful, for example, if the user only sometimes wears a light 34 with his or her loupes 32.

The cut outs 30, 102 described above are essentially U-shaped and extend from the center of the top edge downward. This shape may be advantageous in that the top opening makes it easier to seat the loupe light 34. However, as those of skill in the art will appreciate, any opening sufficient to admit a loupe light 34 will suffice in other embodiments of the invention.

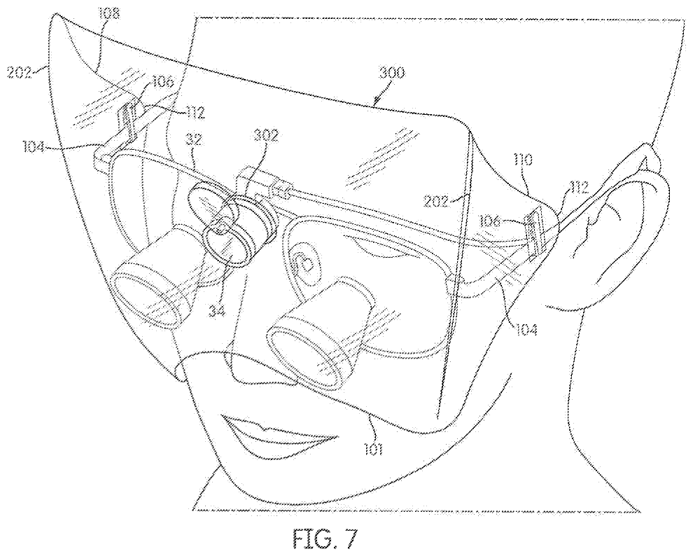

FIG. 7 is a perspective view of a face shield, generally indicated at 300, according to another embodiment of the invention. The face shield 300 is similar in most all respects to the face shield 200 described above. However, the face shield 300 does not have the cut out 30, 102 of the other embodiments. Instead, an opening 302 is provided in the central portion of the face shield 300, a distance from the top edge. In the illustrated embodiment, the opening 302 is circular and is just larger than the loupe light 34 itself. The opening 302 may be, e.g., 1-3 inches in diameter, depending on the diameter of the loupe light 34. While the face shield 300 has a circular opening 302, the shape is not critical; other embodiments may use ovals and other shapes.

The face shield 300 may provide better protection for the forehead and upper areas of the face than the other face shields 100, 200 and face shield portions 14; however, seating the loupe light 34 in the opening 302 may require slightly more effort than with a cut out 30, 102.

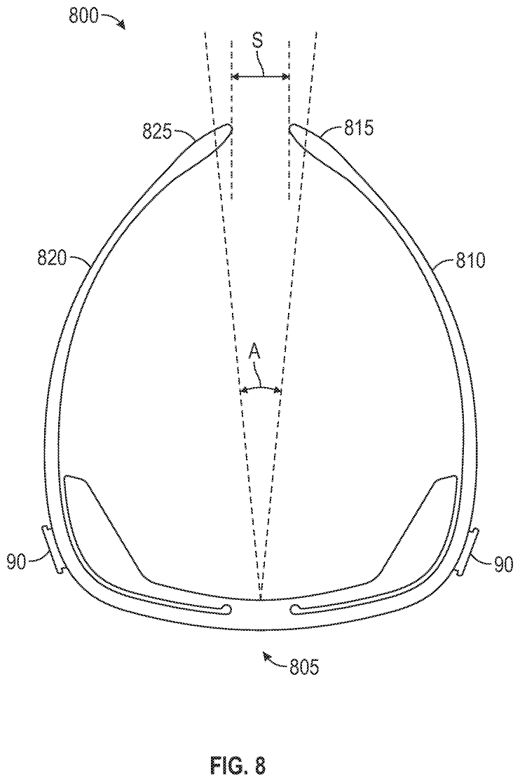

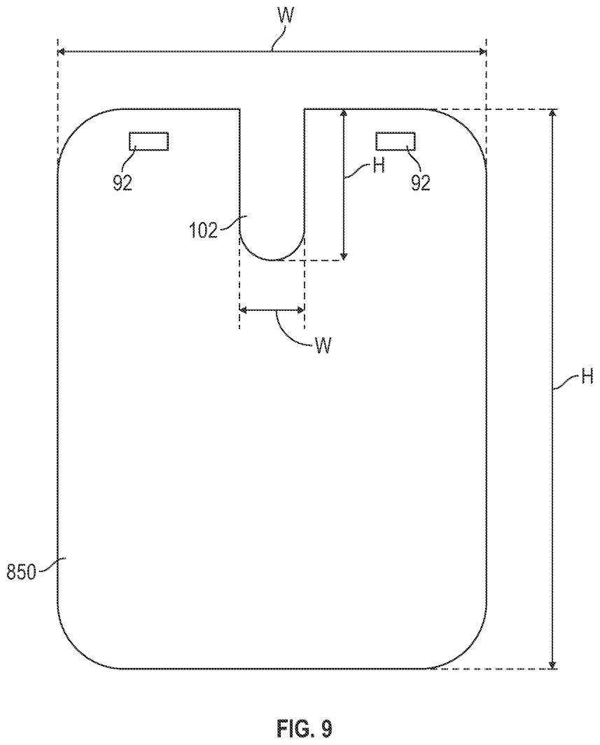

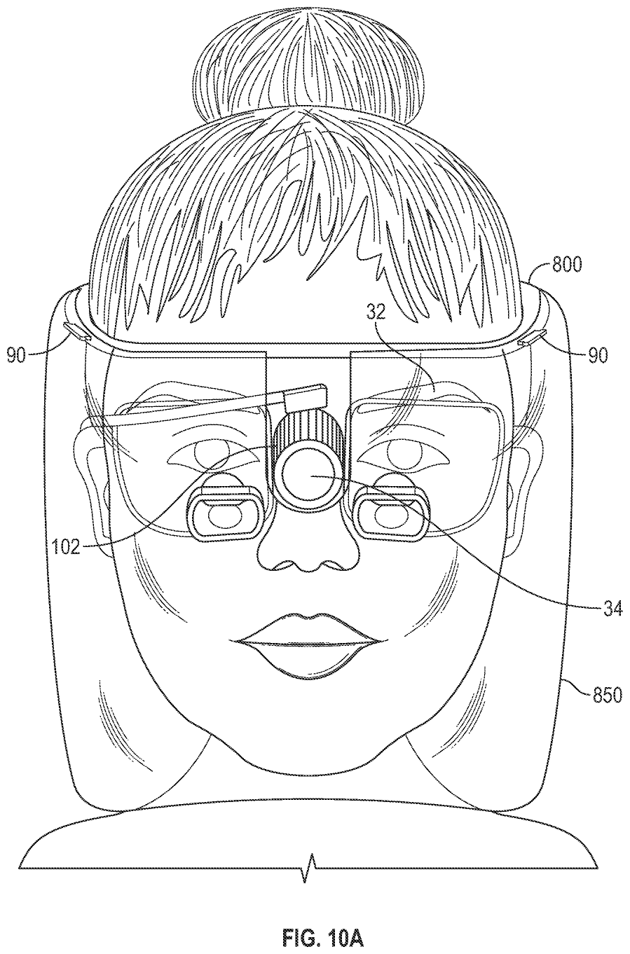

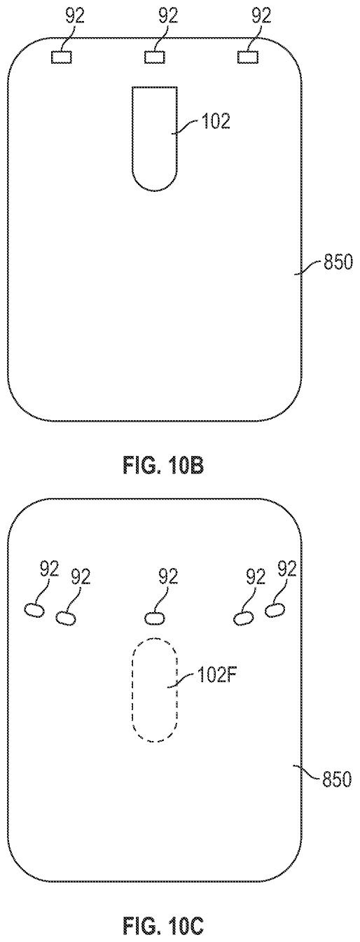

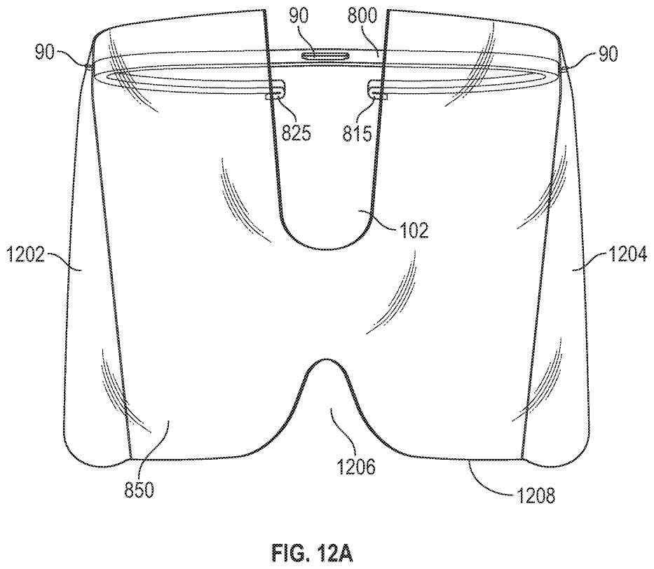

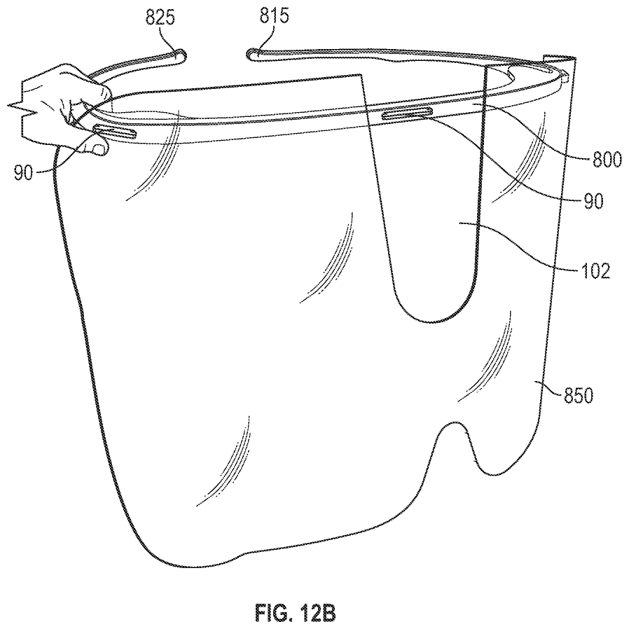

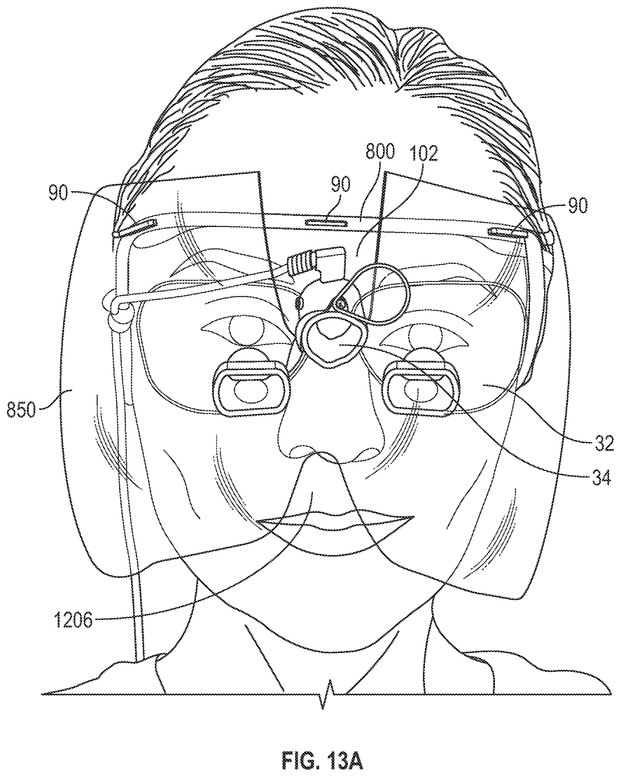

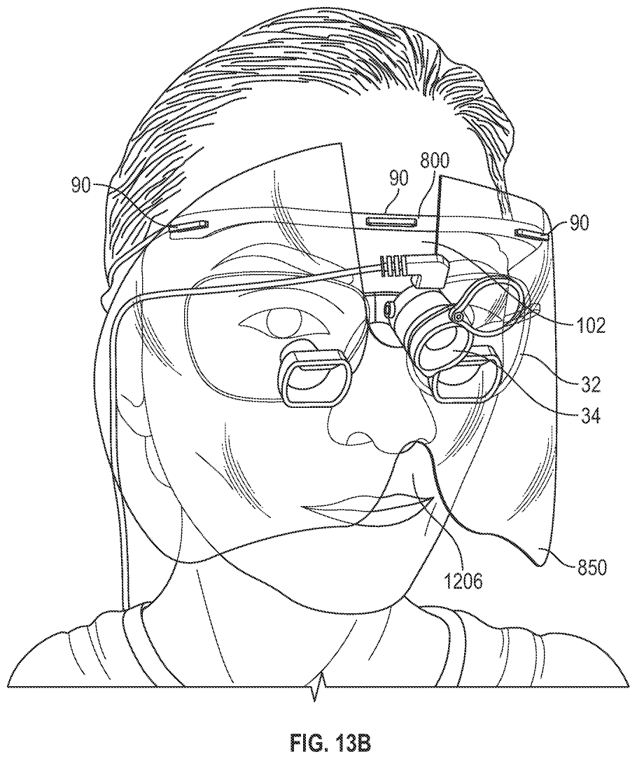

In one embodiment, a face shield is provided with a shield frame. The use of the shield frame permits the use of the shield without the requirement for the user to be wearing loupes or any other eyewear to which the face shield is attached. As a result, the shields for use with the shield frame may have any or all of the features as to those of the shields described in FIGS. 1-7 with the inclusion of post openings which are used with posts to secure the protective shield to the shield frame as described below in FIGS. 8-18F. Additionally or optionally, the shield frame and shield may be used with other personal protective equipment such as face masks, respirators, goggles or eyewear. In still further shield embodiments for use with a shield frame, the shield height (H) and width (W) may be adjusted into a large variety of different configurations including, without limitation, full face coverage from the shield frame down (FIGS. 9 and 10A); full face coverage from the shield frame down and extended coverage above the forehead (FIG. 10C); full face coverage with contoured bottom edge and accommodation for face mask (FIG. 12A-13B) as well as adjustment in width (W) and positioning of one or more post openings to provide a wraparound type of coverage with the shield side edges extending along the left side and right side. These and additional alternative embodiments and advantageous features will be appreciated in the description that follows.

FIG. 8 is a top down view of a shield frame embodiment. The shield frame 800 comprises a shield frame front or central portion 805. On either side of the frame front 805 is a shield frame support post 90. A left side piece 810 extends back from a left end of the front portion 805. The left side piece 810 comprises a left side end piece 815. A right side piece 820 extends back from a right end of the front portion 805. The right side comprises a right side end piece 825. There is a spacing S between the right end piece 825 and the left side end piece 815. An angle A is defined by a mid point of the front portion 805 and the two end pieces. In some embodiments, a spacer is positioned on an inner surface of the central portion. The spacer can comprise a soft, deformable, and/or conformable material (e.g., foam, gel, etc.). In some embodiments, the spacer is configured to space the shield from a user's face to create space for loupe magnifiers, as well as to provide comfort to a user when the frame rests against a forehead. In some embodiments, the spacer may be positioned on an outer portion of the frame. In such embodiments, a separate rest may be provided on an inner portion of the frame to enhance comfort.

FIG. 9 is a front view of a full face protective shield 850 having a central opening sized for a loupe light and openings sized and shaped for securing the protective shield to a shield frame post. The shield 850 comprises a width W and height H. Post openings 92 are positioned along a top portion of the shield 850. A cut out 102 extends down from the top edge of the shield 850. The cut out 102 generally comprises a U-shape. The cut out 102 comprises a width w and height h. Unless otherwise described, the cut out 102 may comprise any combination of features as described with respect to cut out 30.

FIG. 10A is a front view of a full face protective shield 850 of FIG. 9 coupled to the shield frame 800 of FIG. 8 worn by a user who is wearing a pair of loupes 32 with the loupe light 34 shown in the opening 102 of the protective shield 850. The support posts 90 are at least partially inserted through the post openings 92 of the shield 850, thereby securing the shield 850 to the frame 800.

FIG. 10B is a front view of an alternative embodiment of a full face protective shield of FIG. 9 having a loupe light opening formed so that a central post opening is provided for an additional attachment point to the shield frame. The shield 850 comprises three post openings 92 positioned along a top portion of the shield 850. A cut out 102 is positioned in an area below the post openings 92. The cut out 102 is essentially horizontally centered on the face shield, and is positioned beneath the top portion of the face shield, beneath where the post openings are positioned. Other positions may also be possible.

When a user is wearing loupes with a loupe light, the cut out allows the loupe light to pass through the face shield, thus making it easier to wear loupes, a loupe light, and the mask at the same time.

The cut out 102 can be connected at its top edge. For example, the cut out 102 can be scored or prebent to allowed for easy bending when pushed out by the loupe light 34. In some embodiments, it is not scored or prebent, but can still be pushed out upon application of force (e.g., by the loupe light).

The cut out 102 of the illustrated embodiment is wider at the top and narrower at the bottom, and the bottom may be rounded (i.e., to match or approximate the curvature of a typical loupe light). The shape of the cut out 102 may be different in other embodiments—for example, the bottom may be squared, and the top may have a different taper or no taper at all. In one embodiment, for example, the cut out 102 may be about 2.5 inches at its top, about 2 inches at its bottom, and with a height of about 2.5 inches, which provides enough room to accommodate a typical loupe light. However, other embodiments may use different dimensions, and as was noted above, the cut out 102 need not taper in all embodiments. In other words, the cut out 102 may have straight sides and a rounded bottom or straight sides and a squared-off bottom.

While the sidewalls of the cut out 102 are completely straight in the illustrated embodiment, that need not be the case in all embodiments. The sidewalls may instead have curvature of various types, either continuous or discontinuous. In other words, the sidewalls may be only substantially—but not completely—straight, or they may not be straight at all. However, a straight-sided cut out 102 may be easier to manufacture.

As a general matter, it is advantageous if the cut out 102 has the minimum dimensions necessary to admit the loupe light. Put another way, it is advantageous if the cut out 102 admits the loupe light but otherwise compromises the protective function of the face shield portion as little as possible. As can be appreciated from the figures, the cut out 102 is more vertical than horizontal. Put another way, the width is typically at most equal to the depth, and in many cases, the cut out 102 may be deeper than it is wide.

In some embodiments, the shield may be made with no cut out 102. In some embodiments, masks may be made with a perforated frangible portion that can be completely or partially torn off to create a cut out like the cut out 102. Of course, the user is under no obligation to remove a frangible portion if one is present, and may use a face mask without removing a frangible portion if, for example, he or she does not wish to wear a loupe light 34.

FIG. 10C is a front view of an alternative embodiment of a full face protective shield 850 of FIG. 10B having a frangible loupe light opening 102F. Unless otherwise described, the opening 102F can be similar to opening 102 described with respect to FIG. 10B. The face shield 850 comprises two oval shaped post openings 92 on either side and one centrally located post opening 92 positioned above the opening 102F and an upper edge extends above the post openings 92 for additional coverage of the user's head.

While some embodiments may be shown or described as having a cut out starting at the top edge of the face shield (e.g., FIG. 9, FIG. 10A), it will be appreciated that any embodiment of a face shield described herein can be modified so that the cut out is positioned below a top portion of the face shield, allowing, for example, for connection of a central or near-central post opening in the face shield to a corresponding post in a shield frame.

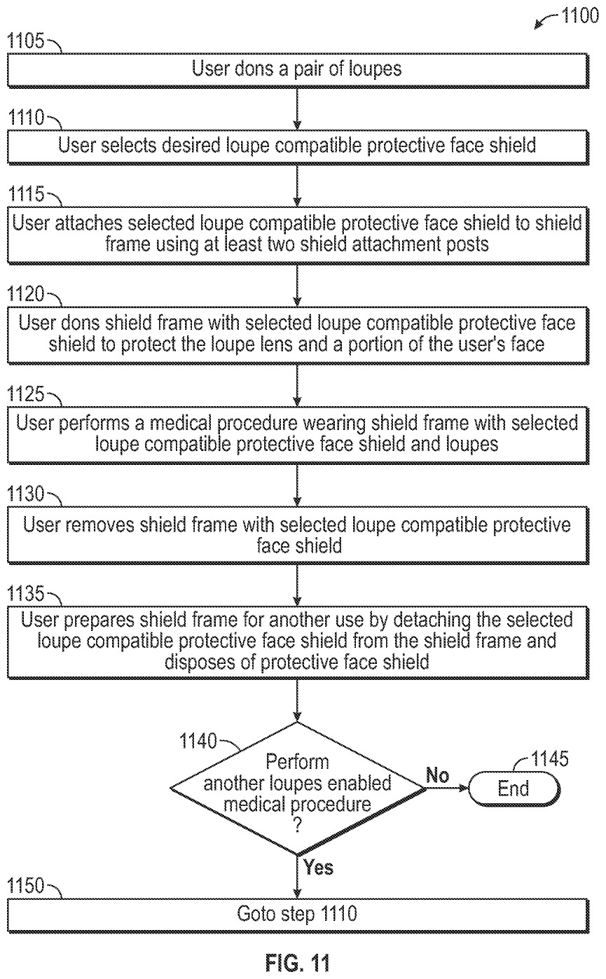

FIG. 11 is a flow chart of an exemplary method 1100 of selecting a protective face shield for use with a shield frame and donning the shield frame while wearing a pair of loupes. The method comprises the step 1105 of the user donning a pair of loupes. The method comprises the step 1110 of the user selecting a desired loupe compatible protective face shield. The method further comprises the step 1115 of the user attaching the selected loupe compatible protective face shield to a shield frame using at least two shield attachment posts. The method comprises the step 1120 of the user donning the shield frame with the selected loupe compatible protective face shield to protect the loupe lens and a portion of the user's face. The method can comprise the further step 1125 of the user performing a medical procedure wearing the shield frame with the selected loupe compatible protective face shield and loupes. The user can remove the shield frame with the selected loupe compatible protective face shield at step 1130. At step 1135, the user can prepare the shield frame for another use by detaching the selected loupe compatible protective face shield from the shield frame, and can dispose of the protective face shield. At step 1140, the user can decide whether they will perform another loupes enabled medical procedure. If yes, the user can return to step 1110.

FIGS. 12A and 12B are a front view and a partial right side perspective view of an embodiment of a partial face protective shield 850 coupled to a shield frame 800. The frame 800 comprises a central portion, a right side piece, and a left side piece. The right side piece comprises a right side end 825. The left side piece comprises a left side end 815. The frame comprises a plurality of support posts 90 positioned along the frame 800. The shield 850 is attached to two of the support posts 90. The frame comprises support posts 90 to which the shield is not attached. A cut out 102 extends down from a top edge of the shield 850. The shield 850 comprises a right edge 1202 configured to fold around a right side of the face. The shield 850 comprises a left edge 1204 configured to fold around a left side of the face. The shield comprises a cut out 1206 along a bottom edge 1208 of the shield. The cut out 1206 can be configured to provide space for a user's nose. The cut out 1206 can comprise a rounded edge, and may resemble a bell shape, in some embodiments.

FIGS. 13A and 13B are a front view and a partial right side perspective view of a partial face protective shield coupled to a shield frame of FIG. 12A worn by a user wearing loupes 32. The loupe light 34 is shown extending through the opening 102. The shield frame 800 is positioned around the forehead of the user. The shield 850 is attached to the shield frame 800 by connecting two of the side support posts 90 of the frame to openings 92 in the shield. The cut out 1206 is shown just below the user's nose.

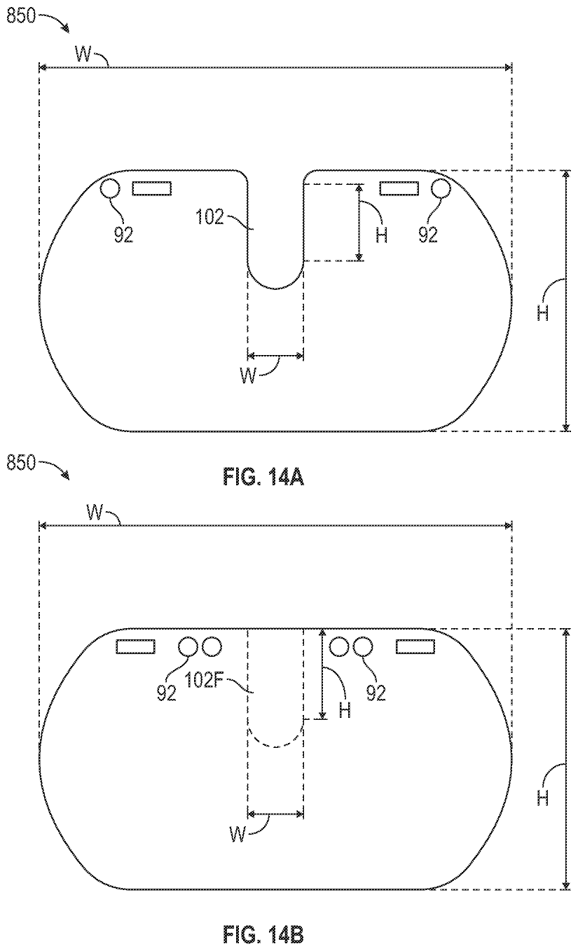

FIGS. 14A-16 provide various embodiment of face shields comprising cut outs and post openings. Unless otherwise described, any of the face shields, cut outs, and post openings may comprise any combination of features described with respect to other embodiments (e.g., those features described with respect to FIGS. 8-13B).

FIG. 14A is a face protective shield 850 adapted for use with a shield frame. The protective shield 850 comprises a width W of about 17-18″ (or about 6-20, or about 10-20, or about 15-18, etc.) and a height H of about 7-8″ (or about 5-10″ or about 6-9″, etc.). The protective shield 850 comprises an elongated opening 102 for a loupe light comprising a height h of about 2-3″ (or about 1-4″ or about 1.5-3.5″, etc.) and a width w of about 1-2″ (or about 0.5-2.5″) and a mixture of types of post openings 92 corresponding to those on the shield frame. The mixture of post openings can more securely attach the face shield to a frame. In some embodiments, the mixture of types of post openings can allow for attachment to different frames having different kids of posts.

FIG. 14B is a face protective shield 850 adapted for use with a shield frame. The protective shield comprises a width W of about 17-18″ (or about 6-20, or about 10-20, or about 15-18, etc.) and a height H of about 7-8″ (or about 5-10″ or about 6-9″, etc.). The protective shield 850 comprises an elongated frangible opening 102F for a loupe light and a mixture of types of post openings 92 corresponding to those on the shield frame.

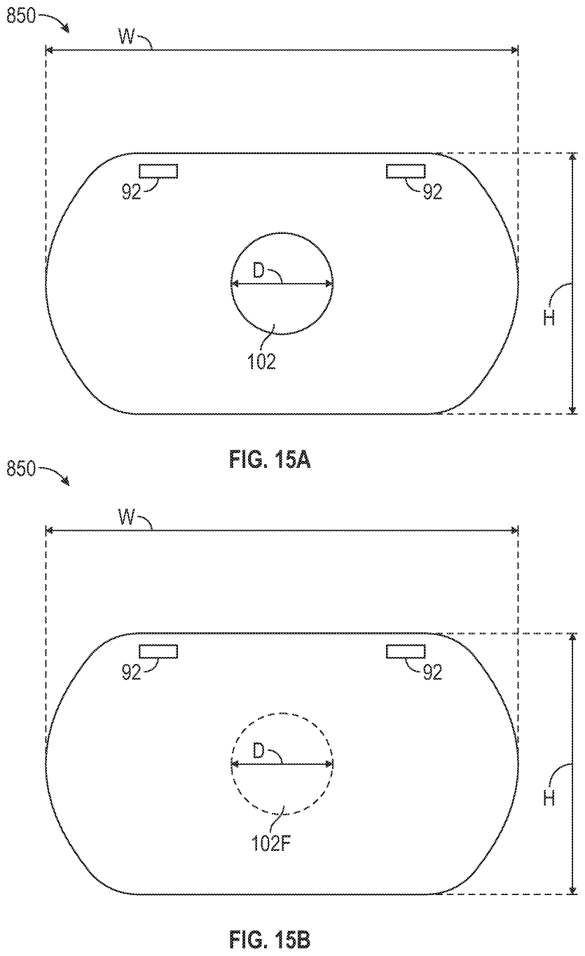

FIG. 15A is a face protective shield 850 adapted for use with a shield frame having a circular opening 102 for a loupe light. The shield 850 comprises a width W of about 17-18″ (or about 6-20, or about 10-20, or about 15-18, etc.) and a height H of about 7-8″ (or about 5-10″ or about 6-9″, etc.). The shield 850 can comprise straight upper and bottom edges and rounded side edges. The opening 102 comprises a diameter d of about 1-2″ (or about 0.5-2.5″). The shield 850 comprises a pair of rectangular post openings 92 corresponding to those on the shield frame.

FIG. 15B is a face protective shield 850 adapted for use with a shield frame having an circular frangible opening 102F for a loupe light with a diameter d. The shield 850 comprises a pair of oval shaped post openings 92 corresponding to those on the shield frame. The shield 850 can comprise straight upper and bottom edges and rounded side edges.

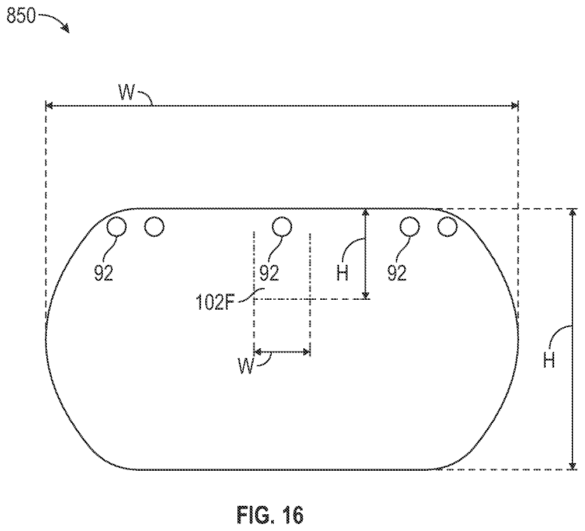

FIG. 16 is a face protective shield 850 adapted for use with a shield frame having a frangible flap opening 102F for a loupe light. The shield comprises a width W of about 17-18″ (or about 6-20, or about 10-20, or about 15-18, etc.) and a height H of about 7-8″ (or about 5-10″ or about 6-9″, etc.). The sides and bottom of the opening 102F are frangible while the top portion of the opening is connected to the shield 850. The opening 102F comprises a height h of about 2-3″ (or about 1-4″ or about 1.5-3.5″, etc.) and a width w of about 1-2″ (or about 0.5-2.5″). The shield 850 comprises a combination of paired side post openings 92, a central post opening 92, and another pair of side post openings 92 corresponding to those on the shield frame. The shield 850 can comprise straight upper and bottom edges and rounded side edges.

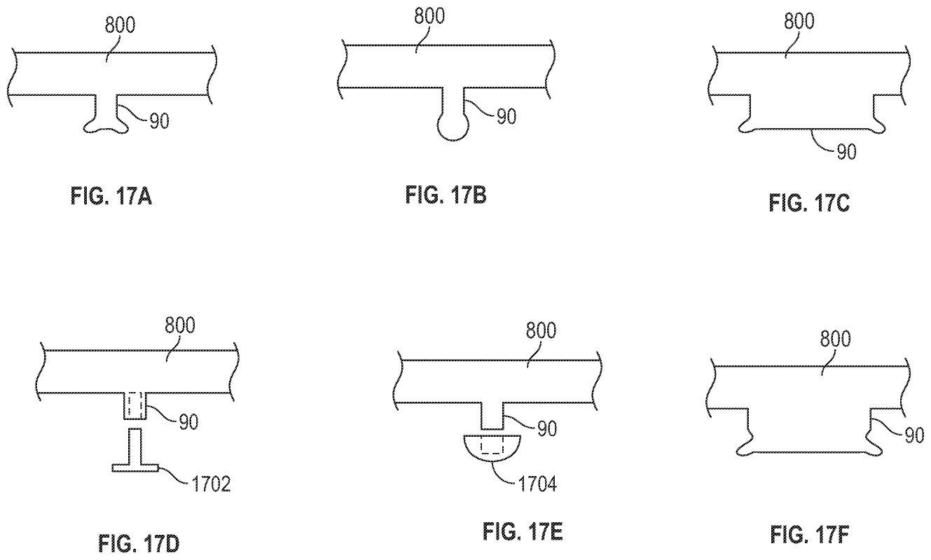

FIGS. 17A-17F show a top view of various embodiments of post shapes attached to a frame.

FIG. 17A illustrates a partial cross section of a portion of a shield frame 800 and a post 90 having a flared tip.

FIG. 17B illustrates a partial cross section of a portion of a shield frame 800 and a post 90 having a ball or rounded tip.

FIG. 17C illustrates a partial cross section of a portion of a shield frame 800 and a post 90 having a platform or plateau shaped tip.

FIG. 17D illustrates a partial cross section of a portion of a shield frame 800 and a hollow post 90 adapted for use with a T-insert 1702 to secure the shield to the shield frame.

FIG. 17E illustrates a partial cross section of a portion of a shield frame 800 and a post 90 adapted for use with a cap 1704 to secure the shield to the shield frame.

FIG. 17F illustrates a partial cross section of a portion of a shield frame 800 and a post 90 having a platform or plateau shaped tip similar to FIG. 17C with a recess formed in the post. A recess may be provided to secure the shield at a spacing from the shield frame or to allow space for a gasket, seal or other material on the shield frame to be disposed between the shield frame and the shield.

The views of the post 90 embodiments described herein may also include any of a variety of different shapes when viewed from the front of the frame. A number of exemplary shapes are envisioned in the following non-limiting examples.

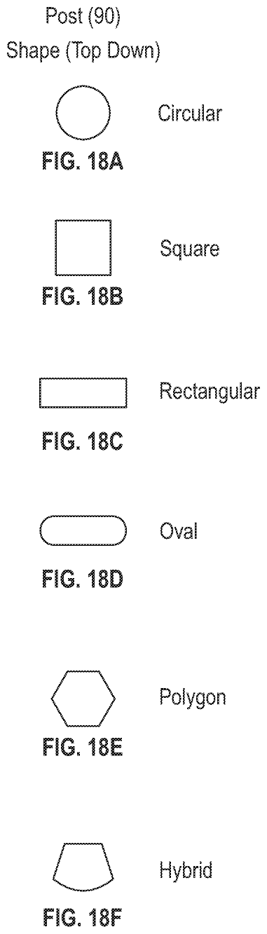

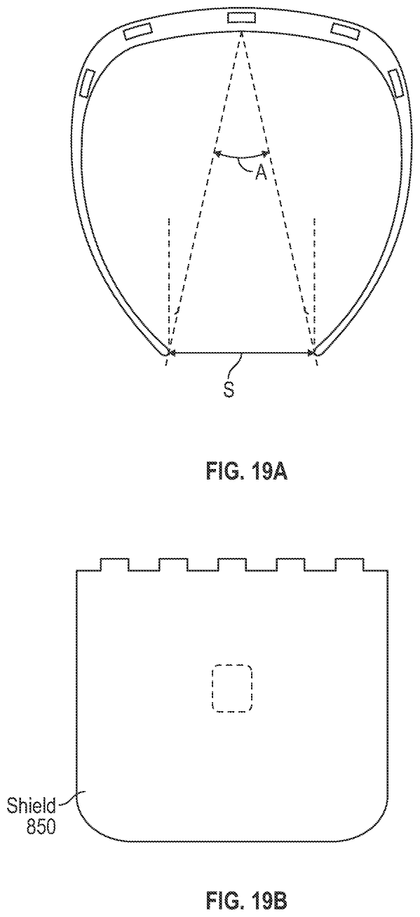

FIG. 18A is a front view of a post 90 showing an overall circular shape.

FIG. 18B is a front view of a post 90 showing an overall square shape.

FIG. 18C is a front view of a post 90 showing an overall rectangular shape.

FIG. 18D is a front view of a post 90 showing an overall oval shape.

FIG. 18E is a front view of a post 90 showing an overall polygonal shape.

FIG. 18F is a front view of a post 90 showing an overall hybrid shape.

In some embodiments, the post openings (e.g., like those shown in FIGS. 18A-18F) comprise an opening through which a post can be inserted. In some embodiments, instead of a pre-formed opening, the shape of the post opening is scored, embossed, or perforated onto the face shield. In such embodiments, the posts may be pushed through the pre-scored or perforated opening, to open up at least a portion of the opening and push the post through the at least a portion of the opening.

In other additional and alternative embodiments, the shield frame and shield may engage in a complementary tab and slot arrangement. As with other embodiments, the engagement mechanism of action between the shield and shield frame may be of any suitable configuration which will maintain engagement of the shield to the frame under the circumstances of the procedure or activity being performed by the user while wearing the shield frame and attached shield. As with the embodiments and variations above, the slot and tabs may be adapted for use on shield or frame so long as the shield remains in place during use and that the shield may be removed after use without damaging the shield frame engagement mechanism or technique.

FIG. 19A is a bottom up view of a shield frame having one or more slots, grooves or receivers to engage with a correspondingly shaped tab on a protective shield adapted for use with the shield frame. The slots, grooves or receivers may include friction fit, shape, dimension, bearings, bumps, material, or other such design modifications that will allow a simple movement to engage, secure and then release the shield from the frame. In one embodiment, the locking motion of the shield to the frame is push in to lock and pull out to remove. In another embodiment, there motion of the shield to the frame is slide along the frame, insert, lock, with a reversal of that motion to release the shield from the frame. In still another variation, a lever or slide may be used to lock and hold the shield to the frame. Movement of the lever or slide may operate a clamp, cam or other mechanical locking mechanism to secure a portion of the shield to the frame.

FIG. 19B is a front view of a protective shield having a series of tabs along the upper edge that are adapted to engage with a corresponding slot, groove or receiver formed in a surface of the shield frame. The position of the tabs in this illustrative embodiment is as follows: (a) one tab in the central portion of the frame front section; (b) one tab to engage near the transition from the front piece to the left side; (c) one tab to engage near the transition from the front piece to the right side piece; (d) one tab to engage along the right side piece and (e) one tab to engage along the left side piece. Each one of these positions is exemplary and more or fewer tabs, placement of each along the frame, as well as different shapes, sizes, orientations and other design factors as described above may also be included. Still further, in other aspects the number and placement of tabs/slots may be used to provide the desired amount of wrap around protection desired by a user or as in reasonable by the activity or procedure performed while using the shield frame. In one aspect, one or more tabs/slots pairs are providing along the left side and the right side to a position adjacent to the user's temple, to the user's ear or to a position past the user's ear and the left and right ends. Additionally, this embodiment illustrates a frangible opening that when removed would provide access for a loupe light worn by a user. It is to be appreciated that the frangible scoring provided in this and other embodiments is selected to the type of plastic used for the shield with a size and spacing that will both allow the frangible section to be removed with as little distortion to the visual field as possible. This maintains the usefulness and dual purpose of the shield frame and shield for full face protection while still allowing modification for use of a light worn by the user. Still further, the shields having frangible scoring may be provided with a visually transparent material like a patch or sticker that may be used to cover the frangible openings thereby reducing the risk of exposure via the frangible openings while allowing the shield to be repurposed during a shortage of personal protective equipment.

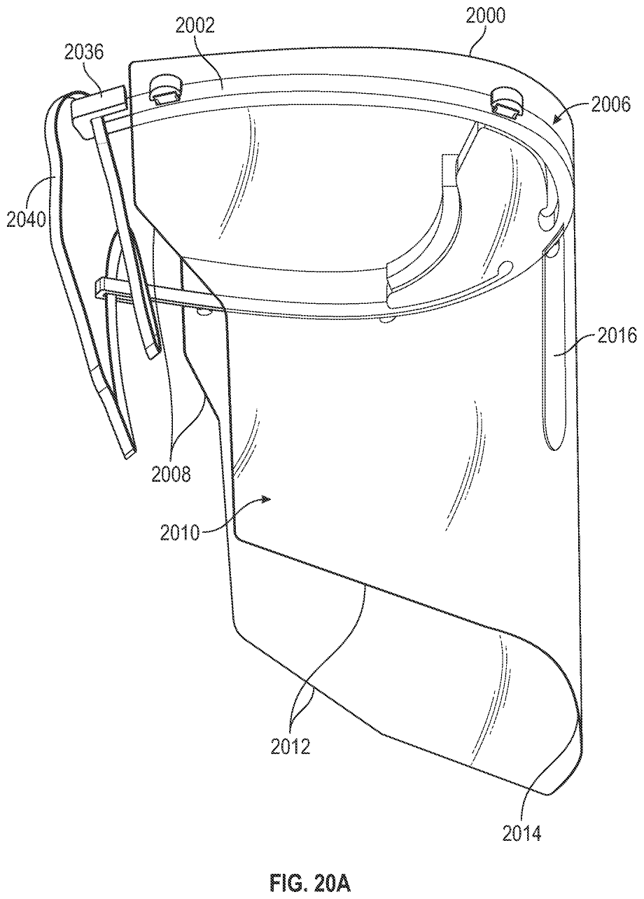

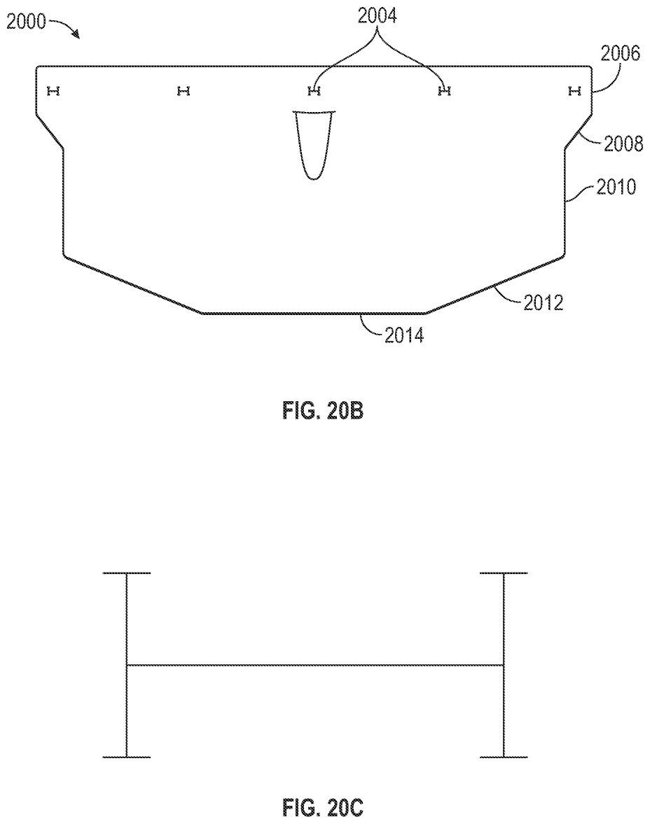

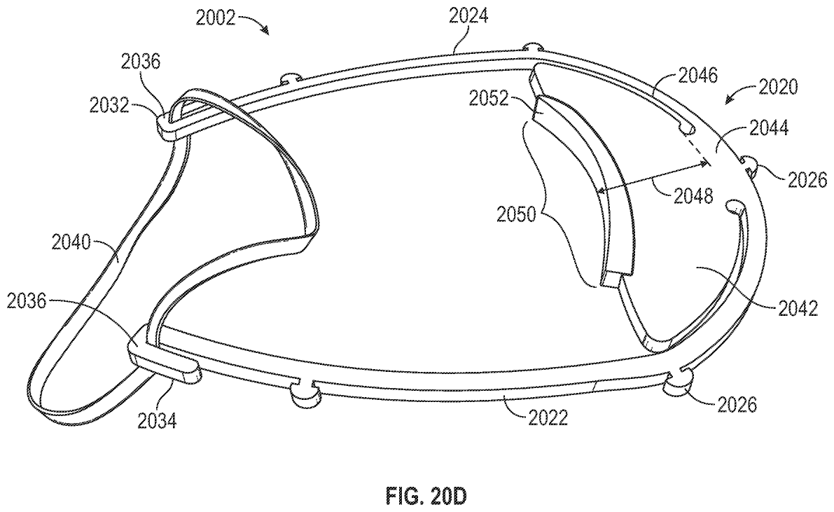

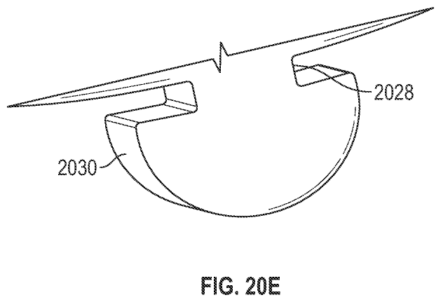

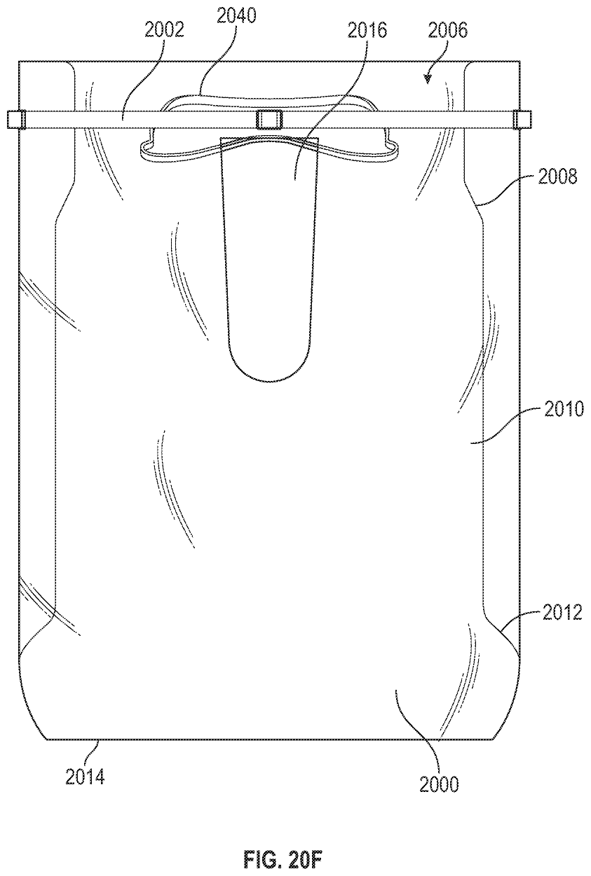

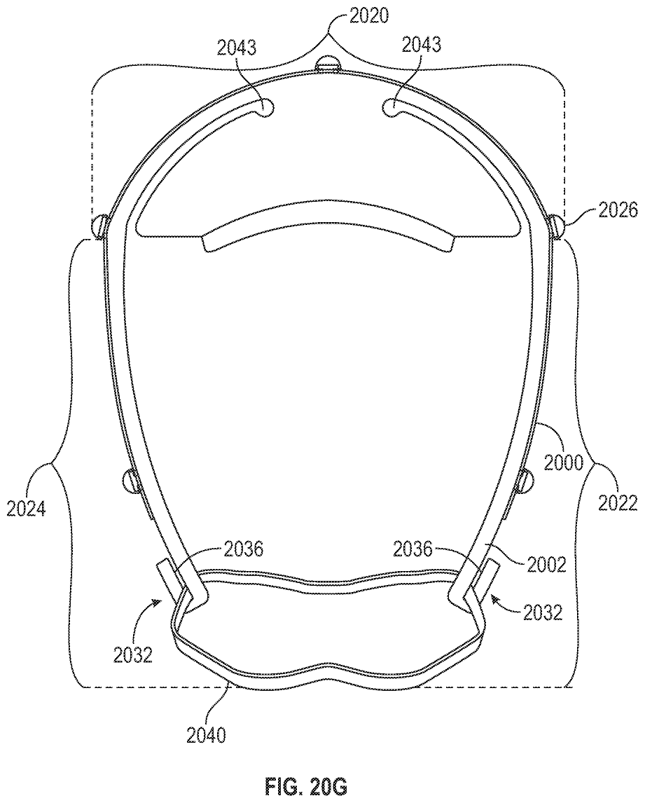

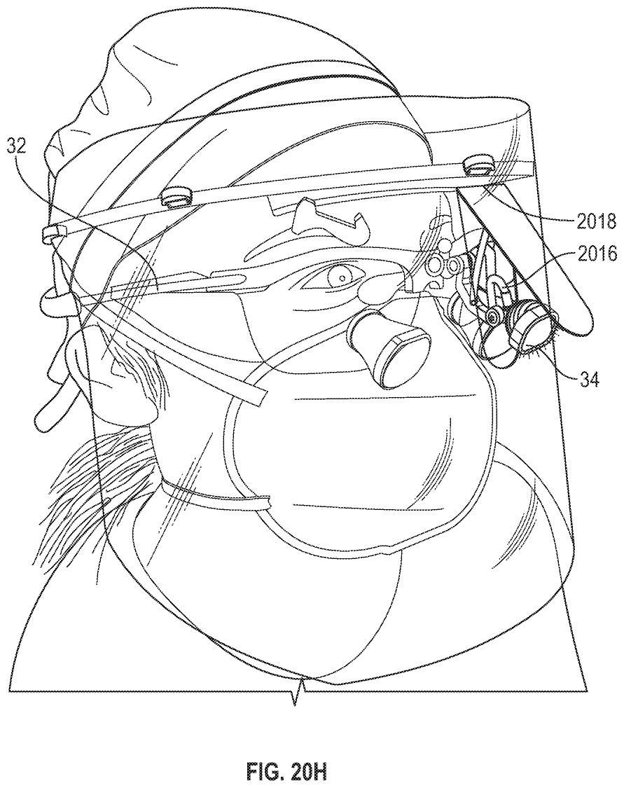

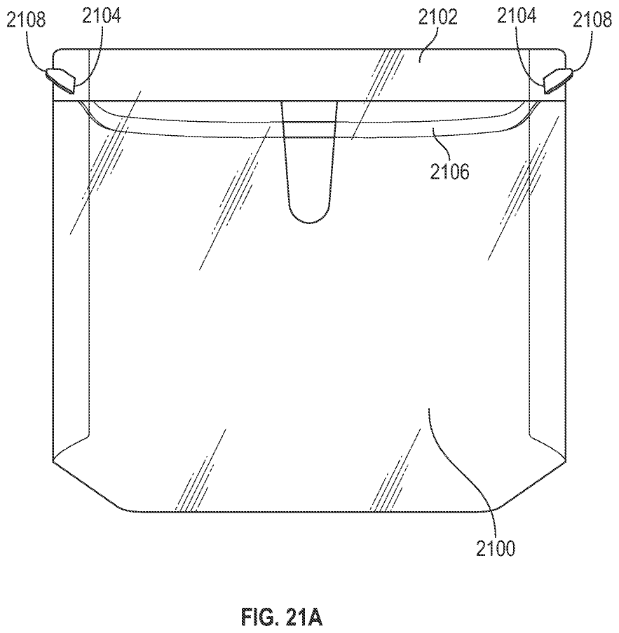

Referring now to FIGS. 20A-20H another embodiment of a protective shield 2000 and shield frame 2002 are shown. FIG. 20A shows a perspective view of the protective shield 2000 removably connected to the shield frame 2002. FIG. 20F shows a front view of the protective shield removably connected to the shield frame 2002. FIG. 20G shows a top view of the protective shield removably connected to the shield frame.

FIG. 20B shows a front view of the protective shield 2000. The protective shield 2000 comprises a thin piece of clear material. The clear material can be flexible. For example, it may be bent or curved around a user's face when properly positioned on a frame. The protective shield comprises a plurality of post openings 2004 positioned along a top portion 2006 of the protective shield 2000.

In the embodiment shown in FIG. 20B, five post openings are shown generally evenly spaced along the top portion 2006. More or fewer post openings are also possible. In some embodiments, the post openings are not evenly spaced along the shield. The top portion 2006 of the protective shield may comprise a greater width than the remaining portion of the shield. In some embodiments, the side edges of the protective shield 2000 comprise a taper 2008, connecting the top portion 2006 with a mid portion 2010 of the shield.

In some embodiments, the edges of the mid portion comprise a taper 2012 towards the bottom edge 2014 of the shield.

In some embodiments, the top portion 2006 of the protective shield comprise a first width. The mid portion 2010 of the shield comprises a second width, less than the first width. A bottom portion of the shield 2000 comprises a third width, less than the second width.

This shape can advantageously maximize protection all the way to a user's ear without covering the user's ear. Leaving the user's ears uncovered can help prevent interference with hearing and echoing.

FIG. 20C shows an embodiment of a post opening for the face shield. The opening can comprise an H-shape. Each vertical slit of the H-Shape comprises a shorter horizontal slit at each end. Other post openings (e.g., rectangular, H-shaped slits, I-shaped slits, ovular, etc.) are also possible.

The face shield can be configured to lay flat when not connected to the frame. Connection between the frame and the shield can cause the shield to curve around the frame. In some embodiments, sufficient connection between the shield and frame comprises connecting the shield to the frame at a minimum of two connection points (e.g., two post opening/post connections).

As described above with respect to face shields 100, 200, a central portion of the face shield defines a cut out 2016. The cut out 2016 is essentially horizontally centered on the face shield, and is positioned beneath the top portion of the face shield, beneath where the post openings are positioned. Other positions may also be possible.

As shown in FIG. 20H, when a user is wearing loupes 32 with a loupe light 34, the cut out 2016 allows the loupe light 34 to pass through the face shield 2000, thus making it easier to wear loupes 32, a loupe light 34, and the mask at the same time.

As described above, a cut out in the face shield portion can also advantageously allow access to a UV filter attachment on the loupe light. For example, when placing UV sensitive filling material or cements, a user needs access to the loupe light to place the UV filter on the light to slow down the curing process. The user also needs to access the light to remove to the UV filter attachment to finish the procedure. Allowing the user access to the loupe light without having to remove the face shield can greatly increase convenience, hygiene, and/or safety of the procedure.

The cut out 2016 can be connected at its top edge 2018, forming a flap. For example, the cut out 2016 can be scored or prebent to allowed for easy bending when pushed out by the loupe light 34 (e.g., as shown in FIG. 20H). In some embodiments, it is not scored or prebent, but is still a flap that can still be pushed out upon application of force (e.g., by the loupe light).

The cut out 2016 of the illustrated embodiment is wider at the top and narrower at the bottom, and the bottom may be rounded (i.e., to match or approximate the curvature of a typical loupe light 34). The shape of the cut out 2016 may be different in other embodiments—for example, the bottom may be squared, and the top may have a different taper or no taper at all. In one embodiment, for example, the cut out 2016 may be about 2.5 inches at its top, about 2 inches at its bottom, and with a height of about 2.5 inches, which provides enough room to accommodate a typical loupe light 34. However, other embodiments may use different dimensions, and as was noted above, the cut out 2016 need not taper in all embodiments. In other words, the cut out 2016 may have straight sides and a rounded bottom or straight sides and a squared-off bottom.

While the sidewalls of the cut out 2016 are completely straight in the illustrated embodiment, that need not be the case in all embodiments. The sidewalls may instead have curvature of various types, either continuous or discontinuous. In other words, the sidewalls may be only substantially—but not completely—straight, or they may not be straight at all. However, a straight-sided cut out 2016 may be easier to manufacture.

As a general matter, it is advantageous if the cut out 2016 has the minimum dimensions necessary to admit the loupe light 34. Put another way, it is advantageous if the cut out 2016 admits the loupe light 34 but otherwise compromises the protective function of the face shield portion 14 as little as possible. As can be appreciated from the figures, the cut out 2016 is more vertical than horizontal. Put another way, the width is typically at most equal to the depth, and in many cases, the cut out 2016 may be deeper than it is wide.

In some embodiments, the shield may be made with no cut out 2016. In some embodiments, masks may be made with a perforated frangible portion that can be completely or partially torn off to create a cut out like the cut out 2016. Of course, the user is under no obligation to remove a frangible portion if one is present, and may use a face mask without removing a frangible portion if, for example, he or she does not wish to wear a loupe light 34.

FIG. 20D shows a perspective view of an embodiment of a shield frame 2002. The shield frame may be configured to be worn around a user's head at or around the forehead level. The shield frame comprises a central portion 2020. The central portion 2020 is generally configured to be positioned over a user's forehead. The shield frame comprises a right side piece 2022 and a left side piece 2024. It will be appreciated that there may be no actual distinction between the central portion and the side pieces. The central portion and the side pieces may just refer to portions of the overall frame. The right and left side pieces 2022, 2024 are generally configured to be positioned along the side of a user's head from around the temple and extending towards the back of the head from there.

The shield frame 2002 comprises a plurality of support posts 2026. The frame 2002 comprises five support posts spaced along the frame, but more or fewer support posts are also contemplated. The frame may comprises a number of support posts sufficient to securely hold the shield to the frame. The support posts 2026 may be positioned along the central portion and the right and left side pieces. In some embodiments, the number of posts and post openings correspond. In some embodiments, there may be a greater number of posts on the frame than post openings on the shield, or vice versa.

The support posts 2026 may comprise a shape as shown in FIG. 20E. The post 2026 comprises a rectangular post base 2028 with a semi circular head portion 2030. In some embodiments, the post comprises a base portion with a larger head portion (e.g., like the embodiments shown in FIGS. 17A-17C). The cap portion may be rounded in some embodiments (e.g., spherical, ovular, rounded, etc.).

The frame comprises a left end 2032 and a right end 2034. Each end comprises a strap connector 2036. The strap connector 2036 may comprise a hook portion of the frame. For example, the right and/or left side pieces may fold back onto itself at or near the right and/or left end. The strap can be connected in the hook portion formed by the fold. Other strap connectors are also possible (e.g., an aperture in the frame, a clip on the frame, post on the frame, etc.). In some embodiments, the strap can comprise loops at each end, the loops configured to be slide onto each end of the shield frame, similar to an eyeglasses chain.

The strap 2040 can comprise a loop of material, as shown in FIG. 20C. The material may be an elastic material. Other straps are also contemplated (e.g., strip of material, loop of inelastic material, etc.)

In some embodiments, the frame 2002 comprises a spacer 2042 positioned on an inner part of the central portion 2020. In some embodiments, the spacer 2042 is connected to the frame in one region 2044 in the central portion 2020 of the frame 2002. The portions of the spacer 2042 on the right and left side of the region 2044 are not connected to the frame 2002. A notch or space 2043 on either side of the region 2044 can further enhance the flexibility of the spacer and frame. This limited connection can allow some flexibility of the position of the spacer against the forehead of the user, increasing comfort. Other configurations for the spacer are also possible. For example, it can comprise more than one connection region. For another example it can be connected along its entire length.

In some embodiments, the spacer comprises a sheet or piece of material generally matching a shape (e.g., the curve) of the inner edge 2046 of the central portion 2020 of the frame. The spacer extends back (e.g., towards the strap, left and right ends) by a depth 2048 sufficient to allow for magnifiers of a loupe, in some embodiments. This depth may be about 1-2″ (or about 0.3-3″, or about 0.3-5″, etc).

The spacer may have a rounded edge 2050. The rounded edge may be configured to conform to a forehead of a user. In some embodiments, the edge is not rounded.

The edge 2050 may comprise a conforming portion 2052 along some or all of the edge. The conforming portion 2052 may be configured to more comfortably conform to the user's forehead, creating a comfortable yet stable fit for the shield. In some embodiments, the conforming portion 2052 comprises foam (e.g., a foam strip). Other materials are also possible (e.g., silicone, gel, rubber, etc.). In some embodiments, the conforming portion comprises multiple separate pieces.

It will be appreciated that other configurations for the spacer are also possible. For example, in some embodiments, the spacer may comprise multiple parts extending back from the frame to an edge configured to rest on the forehead. A spacer can both create space for loupes and magnifiers as well as create good airflow within the shield. In some embodiments, the increased space can help prevent fogging of the face shield, improving the user's field of view.

In some embodiments, a depth of the spacer can be selected to provide extra space, for example, for higher power magnifiers or longer loupes.

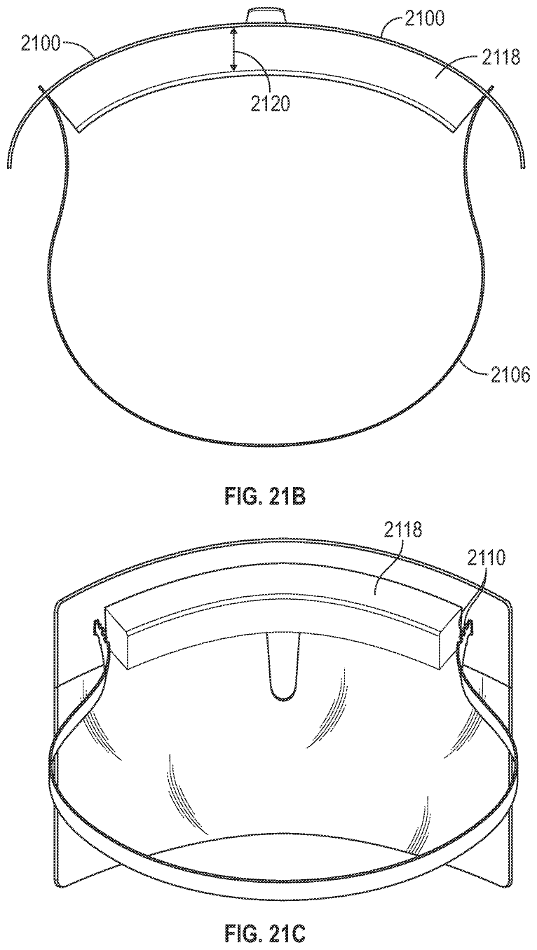

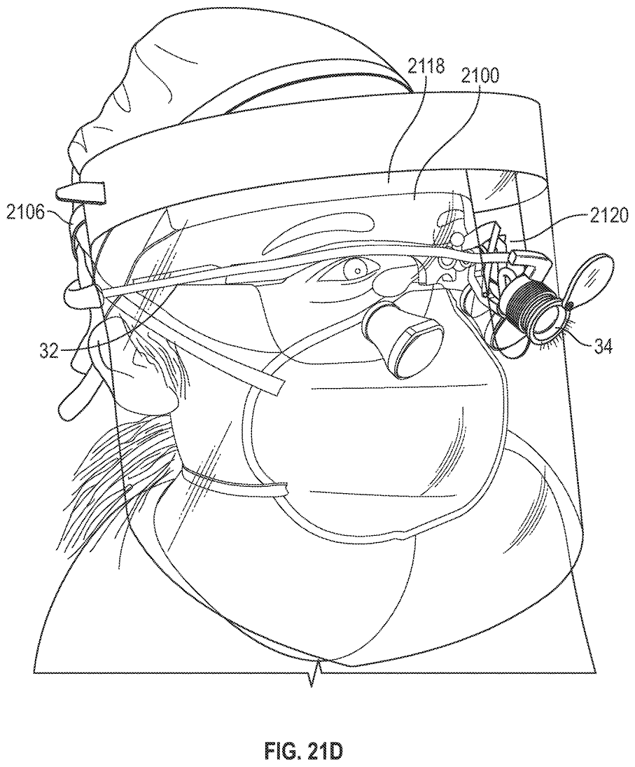

Referring now to FIGS. 21A-21C, a front perspective view, a top view, and a back perspective view of another embodiment of a protective shield 2100 are provided. The protective shield comprises a thin piece of clear material. Similar to the protective shield 2000, the thin piece of clear material may be thin enough to curve around a user's face.

A top portion 2102 comprises a strap aperture 2104 on either side of the shield 2100. The strap aperture 2104 can comprise one or more slits (e.g., H shape slits, cross shaped slits, I shaped slit, etc.). An end of the strap 2106 can be placed through each aperture 2014 from the back of the shield 2100, such that the end 2108 of the strap 2106 sticks out through the aperture 2014 over the front side of the shield 2000. An end portion of the strap can comprise a plurality of notches. A width of the strap on either side of the notch can be greater than the width of the strap at the notch and greater than a width of the strap aperture (e.g., a slit of the strap aperture). These relative dimensions allow the wider portion of the strap to be pulled through the strap aperture until the aperture rests within a thinner notch, securing the position of the strap. A user can select a desired notch to tighten or loosen the strap to the desired fit.

The shield 2100 comprises a spacer 2118 positioned along a back side of the top portion 2102. The spacer can comprise a depth 2120 sufficient to space the shield 2100 away from a user's face and/or create space for loupe magnifiers behind the shield 2100. In some embodiments, the spacer 2118 comprises a conformable material, such as foam. Other materials (e.g., plastic, silicone, gel, rubber) are also contemplated.

The shield 2100 comprises a cut out 2120. Unless otherwise described, cut out 2120 comprises those same features described with respect to cut out 2016. For example, the cut out 2120 can comprise a full cut out, as shown in FIGS. 21A-C or can comprise a flap as shown with respect to cut out 2016. The cut out 2120 is positioned below the top portion 2012 and/or below the spacer 2118. The cut out 2120 can allow a loupe light to pass through the face shield 2100, making it easier to wear loupes, a loupe light, and the mast at the same time.

FIG. 21D shows a user wearing the protective shield 2100 shown in FIGS. 21A-C over a pair of loupes 32. The loupe light 34 is shown extending through the cutout 2120. The spacer 2118 is visible through the shield and rests against the user's forehead. The strap 2106 secures the protective shield to the user's head.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A protective shield and frame, comprising:
a shield frame having a central portion, a left side portion, a left end, a right side portion and a right end;
at least two shield posts extending from the shield frame; and
a protective shield having at least two post openings formed in the shield positioned so that the shield may be releasably attached to the shield frame, the post openings comprising fully formed or partially formed openings or perforations defining the openings, wherein the at least two shield posts are configured to be inserted into the at least two post openings.

2. The protective shield and frame of claim 1 further comprising an opening in the protective shield sized to accommodate a loupe light.

3. The protective shield and frame of claim 2, wherein the opening is frangible.

4. The protective shield and frame of claim 2, wherein the opening is a circle or an oval.

5. The protective shield and frame of claim 2, wherein the opening is a U-shaped slot.

6. The protective shield and frame of claim 2, wherein the opening comprises a flap in which at least a portion of the opening is continuously connected to the shield.

7. The protective shield and frame of claim 2, wherein a top edge of the opening is positioned below a top portion of the protective shield.

8. The protective shield and frame of claim 1, wherein the post opening comprises one or more slits.

9. The protective shield and frame of claim 1, comprising about 3-7 shield posts and 3-7 post openings.

10. The protective shield and shield frame of claim 1, wherein the shield frame comprises a standoff configured to space the protective shield away from a user's face.

11. The protective shield and shield frame of claim 10, wherein the standoff is configured to space the protective shield about 1-2″ away from the user's face.

12. The protective shield and shield frame of claim 10, wherein the standoff comprises plastic or foam.

13. The protective shield and shield frame of claim 10, wherein the standoff comprises a length of foam extending along the shield frame.

14. The protective shield and shield frame of claim 10, wherein the standoff comprises one or more plastic components that extend from the shield frame to a forehead rest portion of the standoff.

15. The protective shield and shield frame of claim 14, wherein the forehead rest portion comprises an edge of the standoff.

16. The protective shield and shield frame of claim 14, wherein the forehead rest portion comprises foam.

17. The protective shield and shield frame of claim 10, wherein a front edge of the standoff and the shield frame are discontinuous along at least a portion of the front edge of the standoff.

18. The protective shield and frame of claim 1, wherein when worn by the user the left end and the right end extend beyond the user's ears, are adjacent to the user's ears or are along the user's temples.

19. The protective shield and frame of claim 1, wherein the left end and the right end are spaced apart by 0.5 inches, 1 inch, 1.5 inches, 2.5 inches or 3 inches.

20. The protective shield and frame of claim 1, wherein an angle formed by the left side portion, the central portion and the left end is between 0 degrees and 90 degrees.

21. The protective shield and frame of claim 1, wherein an angle formed by the right side portion, the central portion, and the right end is between 0 degrees and 90 degrees.

22. The protective shield and frame of claim 1, wherein the shield post shape is circular, square, rectangular, oval, polygon or a hybrid and the one or more post openings are adapted for securing the shield to the shield frame using the post shape.

23. The protective shield and frame of claim 1, wherein the shield post cross section shape has a flared tip, a ball tip, a platform tip, a hollow portion for use with a T-post, a post for use with a cap or a post with a recess and the one or more post openings are adapted for securing the shield to the shield frame using the post shape.

24. The protective shield and frame of claim 1, wherein the post comprises a base and a head portion comprising a greater width or diameter than the base.

25. The protective shield and frame of claim 1, wherein the shield posts are positioned along a front portion of the shield frame.

26. The protective shield and frame of claim 1, wherein the shield posts are spaced along a front portion of the shield frame from a position at or near the right end to a position at or near the left end.

27. The protective shield and frame of claim 1, wherein the protective shield comprises a greater width at a top portion of the shield than a bottom portion of the shield.

28. The protective shield and frame of claim 1, wherein the shield frame comprises a hook or aperture at or near its right end or left end.

29. The protective shield and frame of claim 1, comprising a strap connecting the right end of the frame to the left end of the frame.

30. A method of providing protection to a user, comprising:
donning a shield frame and shield as in claim 1.

31. The method of claim 30 further comprising:
donning a pair of loupes;
adapting the face shield to accommodate the loupes light if needed; and
wearing the shield frame and shield with the loupes light protruding through the shield and the shield frame worn spaced above the temples of the loupes.

32. A protective shield:
a protective shield comprising a thin sheet of clear material, the protective shield comprising a strap connector and a first end and a second end of a top portion of the protective shield; and
a spacer attached to the top portion of the protective shield and comprising a thickness of about 0.5″-2.5″.

33. The protective shield of claim 32, wherein the strap connector comprises a fully or partially formed opening.

34. The protective shield of claim 33, further comprising a strap comprising a strap first end inserted through the strap connector on the first end of the protective shield and a strap second end inserted through the strap connector on the second end of the protective shield.

35. The protective shield of claim 34, wherein the strap first end and the strap second end comprise one or more notches.

36. The protective shield of claim 32, wherein the strap connector comprises one or more slits.

37. The protective shield of claim 32, further comprising a strap extending from the strap connector on the first end to the strap connector on the second end.

38. The protective shield of claim 32, wherein the spacer comprises foam.

39. The protective shield of claim 32 further comprising an opening in the protective shield sized to accommodate a loupe light.

40. The protective shield of claim 39, wherein the opening is frangible.

41. The protective shield of claim 39, wherein the opening is a circle or an oval.

42. The protective shield of claim 39, wherein the opening is a U-shaped slot.

43. The protective shield and frame of claim 39, wherein the opening comprises a flap in which at least a portion of the opening is continuously connected to the shield.

44. The protective shield and frame of claim 39, wherein a top edge of the opening is positioned below a top portion of the protective shield.

45. A method of providing protection to a user, comprising:
donning a shield frame and shield as in claim 32.

46. The method of claim 45 further comprising:
donning a pair of loupes;
adapting the face shield to accommodate the loupes light if needed; and
wearing the shield frame and shield with the loupes light protruding through the shield and the shield frame worn spaced above the temples of the loupes.
